(19) United States
(12) Patent Application Publication
(10) Pub. No.: US 2005/0229844 A1
(43) Pub. Date: Oct. 20, 2005

(54) Device for dispensing granulated material

(76) Inventors: Vic Leach, New Westminster (CA); Wayne King, Surrey (CA); John Worral, Burnaby (CA)

Correspondence Address: Paul Smith Intellectual Property Law, 330-1508 West Broadway, Vancouver, BC, V6JIW8, CA

(21) Appl. No.: 11/104,470

(22) Filed: Apr. 13, 2005

(30) Foreign Application Priority Data
Apr. 14, 2004 (CA) 2,464,594

(51) Int. Cl. B05C 11/02; C04B 2/00

(52) U.S. Cl. 118/110; 118/118

(57) ABSTRACT

A device for dispensing granulated material on a surface. A hopper having a fill opening and a dispenser opening is mounted to a wheeled frame having a control handle. An agitator is mounted in the hopper. A spreader is mounted to the frame below the dispenser opening to propel granulate material falling through the opening towards a baffle mounted to the frame. The baffle deflects the granulated material to the ground. A sweeper mounted to the frame rearwardly of the baffle sweeps granulated material deposited on the ground to ensure even distribution. A power source provides power for the various component parts.

### FIELD OF THE INVENTION

The present invention relates to the field of lawn maintenance equipment and more specifically to a device for dispensing granulated material such as sand, organic matter or other granulated product over a grassy area.

### BACKGROUND OF THE INVENTION

Decorative and recreational grass cover is often required in regions where the native soil composition is less than ideal. In many such areas, the substrate resists the penetration and drainage of water, resulting in thatching and thinning of the desired grass, and infestation by locally adapted pest flora and mosses. After some years of such difficulties, an initially smooth lawn degrades into an uneven area of clumps and hollows.

While chemical treatments are available, these are environmentally damaging and provide only temporary relief from infestation by locally adapted pest flora and mosses.

A non-chemical treatment involves the periodic application of a layer of sand and organic matter to affected grasslands. This non-chemical treatment is recommended not simply as an alternative to environmentally damaging chemical treatments, but as a wholly superior solution which produces permanent and cumulative improvement.

The sand and organic matter treatment is most effective if the procedure takes place shortly after an aeration machine has been used to create perforations in the substrate. Successive sand and organic matter dressings applied in this manner mix with and coarsen the original soil, so that friability, water penetration, and drainage become much more suited to grasses and far less hospitable to the invading species. The more open soil structure also rapidly relieves thatching and, in addition, because rainfall tends to wash the sand and organic matter from peaks and deposit it in adjoining hollows, also improves the flatness of the treated area.

To date, however, no mechanical systems are available that are suited to smaller areas, such as a homeowner's property. Few people are enthusiastic about spreading and raking large quantities of sand and organic matter with hand tools, and the high cost of labour makes a professional service unattractive to most householders and small institutions.

It is therefore an object of an embodiment of the present invention to provide a device for dispensing granulated material such as sand and organic matter on the ground.

Other objects of the invention will be apparent from the description that follows.

### SUMMARY OF THE INVENTION

According to the present invention there is provided a device for dispensing granulated material on a surface, for example for dispensing sand and organic matter on the ground of a grassland area in regions where the substrate soil resists the penetration and drainage of water.

The device has a wheeled frame providing mobility. A container for holding the granulated material is mounted to the frame and has a first opening through which the granulated material is added and a second opening through which the granulated material is dispensed. An agitator is mounted in the container and is adapted to overcome clumping of the granulated material when activated. A spreader is mounted to the frame below the second opening of the container. The spreader is adapted to impart tangential velocity to the granulated material that comes into contact with it during operation. A baffle is mounted to the frame; positioned adjacent to the spreader such that granulated material propelled by the spreader is deflected by the baffle. A sweeper is connected to the frame and acts to sweep the granulated material on the ground surface. The device also has a power source providing power to the wheels, agitator, spreader and sweeper.

Other aspects of the invention will be appreciated by reference to the detailed description of the preferred embodiment and to the claims that follow.

### BRIEF DESCRIPTION OF THE DRAWINGS

These and other features of the invention will become more apparent from the following description in which reference is made to the appended drawings and wherein:

FIG. 1 is a perspective view of a device for dispensing granulated material according to the preferred embodiment of the invention;

FIG. 2 is a side view of the device of FIG. 1;

FIG. 3 is a front view of the device of FIG. 1;

FIG. 4 is a top view of the device of FIG. 1;

FIG. 5 is a bottom view of the device of FIG. 1;

FIG. 6 is a partially sectional perspective view of the device of FIG. 1; and

FIG. 7 is an exploded view of a portion of the device of FIG. 1.

### DETAILED DESCRIPTION OF THE PREFERRED EMBODIMENT

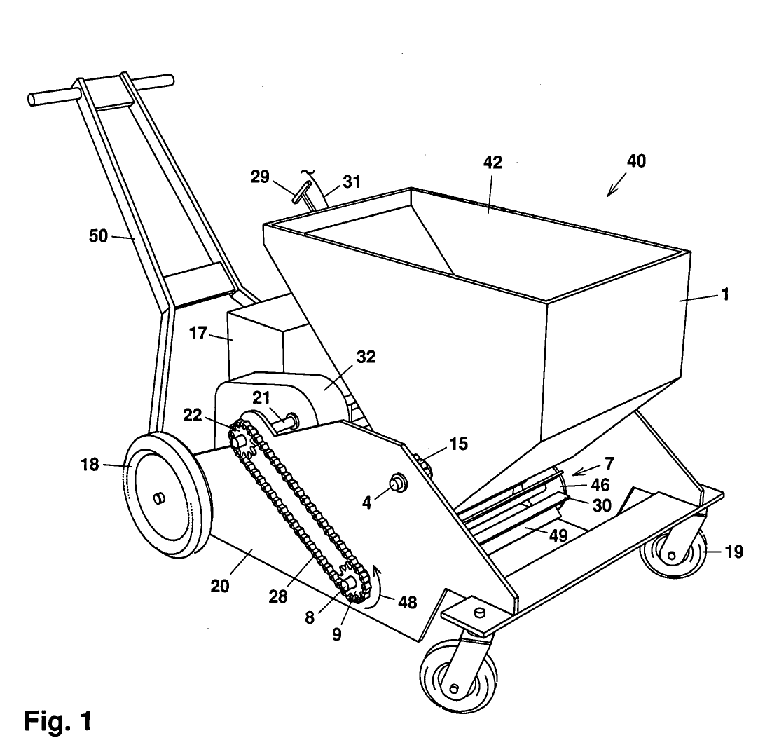

The preferred embodiment of a device 40 for dispensing granulated material onto a surface is illustrated in FIGS. 1 through 7. Sand, organic matter, inorganic matter or other granulated material that is loaded into the device is distributed on the surface over which the device travels. The granulated material is held in a container 1 where an agitator 3 acts to overcome clumping and to feed the granulated material through a dispenser opening or delivery slot 2 in the container 1. The granulated material falls through the delivery slot 2 onto a spreader 7 which acts to impel the sand and/or granular material towards a baffle 10 which further ensures the granulation of any remaining clumps and acts to deflect a consistent swathe of separated granules onto the surface. A rotating sweeper 11 sweeps the granulated material forward and downward, for example when sanding a grassy area, forward and downward between the vegetation on the ground surface. A power source 17 provides motive force to the various elements of the invention. This will now be discussed in more detail with reference to the use of the device for distributing granular material over a ground surface.

Preferably, as illustrated in FIGS. 1-7, the granular material distributing device 40 has a funnel shaped container or hopper 1 within which sand or other granulated material may be placed for use when the device 40 is in operation. The hopper 1 is preferably mounted on a frame 20 having a pair of front wheels 19, a pair of rear wheels 18 and a control handle 50 extending from the rear thereof. It is contemplated that other rolling means may be used such as rollers or tracks provided that they allow the device to be moved over the ground surface onto which granular material is to be applied.

A power source such as a small internal combustion engine 17 transfers power to a drive train 32 mounted on the frame 20 and acts to power those portions of the device requiring it. An electric engine or other such power source would also be acceptable. A transmission system of pulleys, belts, chains and spur gears serves to provide RPM reduction, reversal of rotational direction and to connect the engine to the drive wheels 18. A differential system allows easy turning, even though both rear wheels 18 are driven and this ease is further ensured by castor mounting of the front wheels 19. The drive wheels may be disconnected from the rest of the power train if an operator desires, or if it is required, to maneuver the machine without power.

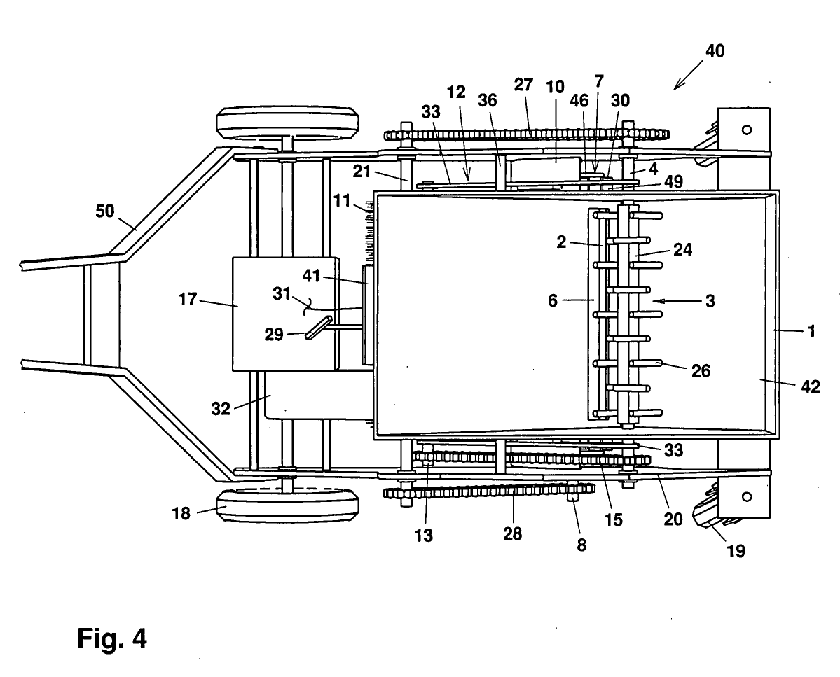

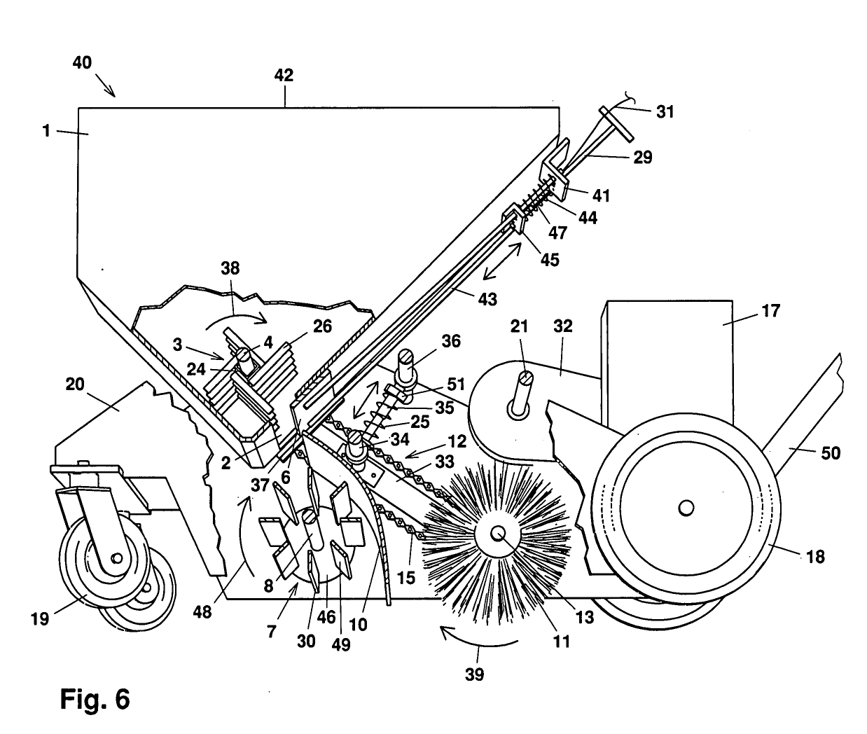

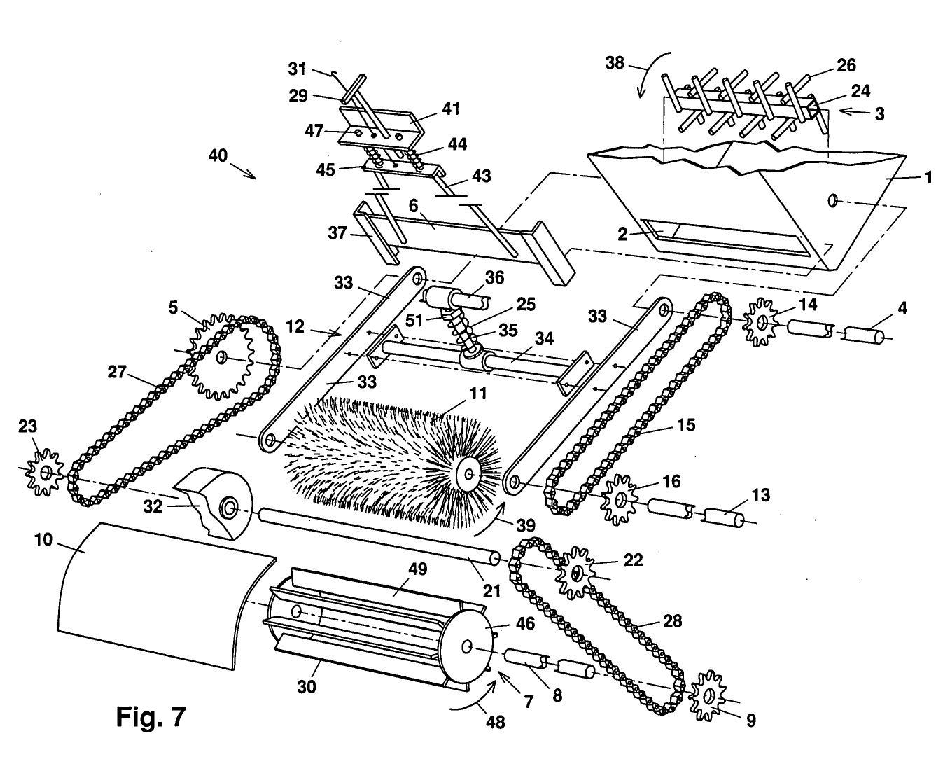

The hopper 1 has a fill opening 42 defined by sides that slope down towards a dispenser opening or delivery slot 2, as illustrated in FIGS. 4, 6 and 7. The delivery slot 2 extends laterally across almost the full width of the hopper 1 such that when open, a curtain of granulated material is issued forth. Preferably delivery slot 2 is covered by a metering slide 6 in the form of a plate that is slidably connected to the hopper. The metering slide 6 is held in position in abutment to the hopper 1 by way of slide brackets 37 (shown in FIGS. 6 and 7), that are fitted on hopper 1 and is operable in the longitudinal direction so as to move between a closed position over delivery slot 2 to a controlled open position.

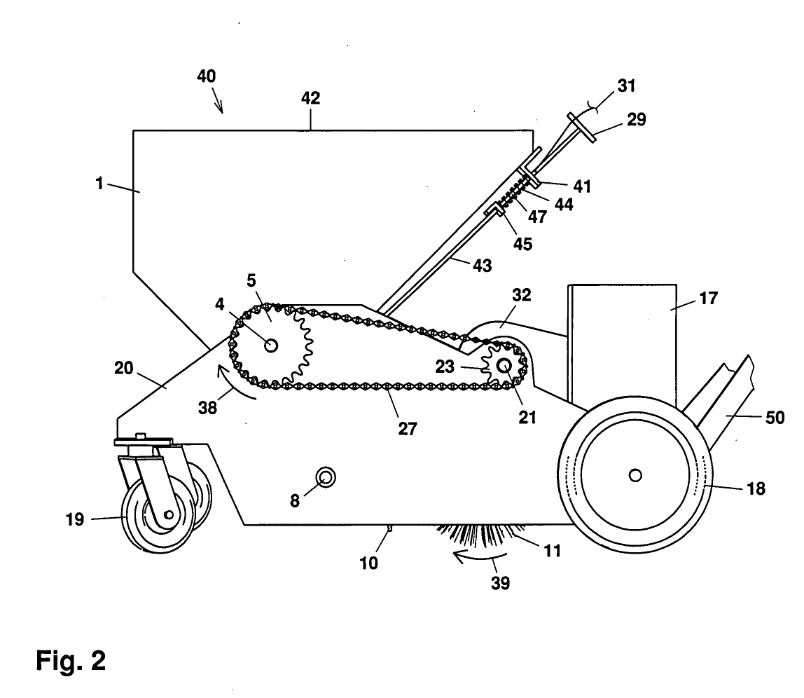

Controls for the metering slide are best illustrated in FIGS. 2, 6 and 7 and are positioned to provide convenient access to the operator. A mounting bracket 41 is connected to the hopper 1. A pair of metering slide rods 43 are connected to the metering slide 6 at one end and to an actuating bracket 45 at the other end. A pair of metering bracket shafts 47 extend from actuating bracket 45 through guide holes in the mounting bracket 41. A spring 44 is fitted over each of the metering bracket shafts 47 so as to be positioned between mounting bracket 41 and actuating bracket 45. The springs 44 act to bias the metering slide in the closed position. A metering slide adjustor 29 is used to limit the travel of the actuating bracket 45 and thus preset the longitudinal opening size of the delivery slot 2. Preferably the slide adjustor is in the form of a threaded rod 29 mounted to the mounting bracket 41 such that unscrewing the rod 29 allows greater slide travel before limiting occurs, whereas screwing the rod 29 provides the opposite effect. A cable 31 connected to actuating bracket 45 is threaded through an aperture in mounting bracket 41 and connected to a control lever (not shown) on the control handle 50. When the operator moves the control lever, it pulls on the cable 31 thereby pulling the metering gate 6 into an open position. Opening of the metering slide 6 is halted when actuating bracket 45 comes into contact with the slide adjustor 29.

It is contemplated that alternative systems to control the opening and closing of, and the size of, the dispenser opening could be used. For example, a slotted roller could be mounted within the slot and rotated such that the roller aperture varied between perpendicular to the hopper aperture and normal to it. A hinged door could also be mounted to close off the slot or to open to varying degrees. Such systems would be acceptable provided simply that they allow control of the rate of delivery of the granulate material through the dispenser opening and that they can withstand the abrasive, clogging and possibly caustic properties of the material being dispensed.

Preferably an agitator 3 is mounted within the hopper 1 as shown in FIGS. 4, 6 and 7. The agitator 3 has a tube portion 24, preferably metal, upon which a plurality of protruding metal tines 26 are connected by way of welding, screwing or the like. Other forms of agitators are possible such as those types that oscillate or rotate in the granular material or those that vibrate the container, all these types acting to overcome clumping of the granular material and assisting the material to move towards the dispenser opening. The agitator 3 is mounted on a drive shaft 4, which in turn is mounted to the hopper 1. The agitator 3 is actuated via a chain drive from the main power train 32. The chain drive comprises a drive shaft 21 connected to the drive train 32, an agitator drive sprocket 23 connected to a drive shaft 21, an agitator drive chain 27 attached at one end to agitator drive sprocket 23 and at the other to an agitator sprocket 5 mounted on drive shaft 4. When in operation, the agitator 3 is rotated by drive shaft 4 in the direction shown by arrow 38, thereby forcing the plurality of protruding tines 26 through the granulated material in the hopper 1. The agitator 3 acts to overcome the clumping tendency of moist granular material and assists the granular material through the delivery slot 2 when open.

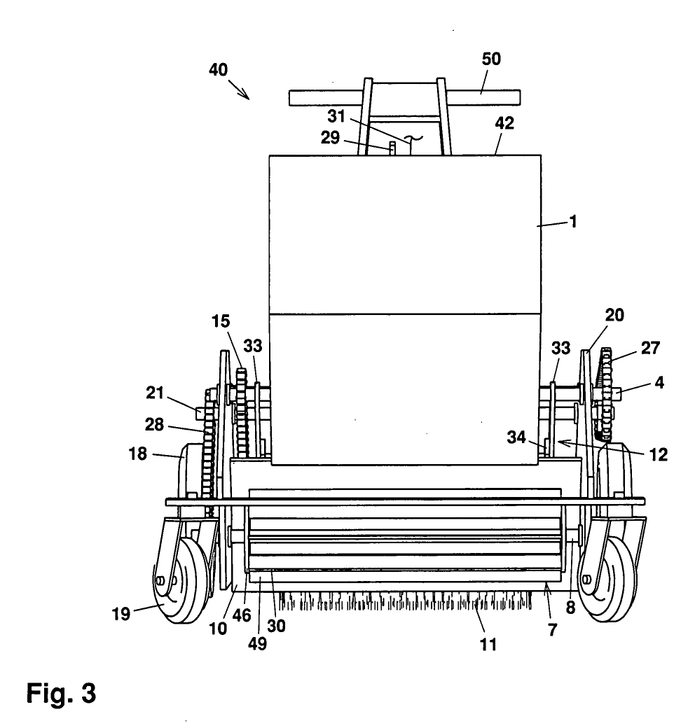

A spreader 7 is mounted to a horizontal drive shaft 8, which in turn is mounted to frame 20 as shown in FIGS. 3, 5, 6 and 7. Preferably the spreader 7 comprises a pair of opposed circular end plates 46 that are mounted on a spreader drive shaft 8. A plurality of bars in the form of radial vanes 30 are connected to the circular end plates 46, preferably by welding. The radial vanes 30 are mounted perpendicular to said end plates 46 and parallel to spreader drive shaft 8 with their working faces 49 lying in a radial plane so as to be perpendicular to the direction of motion. As illustrated best in FIG. 6, the spreader 7 is mounted below delivery slot 2 so that granulated material falling through the opening will come into contact with the working face 49 of radial vanes 30. The spreader 7 is actuated by way of a spreader drive chain 28 that is positioned on a spreader drive sprocket 9 connected to spreader drive shaft 8 and to a drive sprocket 22 connected to drive shaft 21 which in turn is connected to the main power train 32. The direction of rotation of the spreader 7 when actuated is indicated by arrow 48. The gear ratio of the device 40 is adapted to rotate the spreader 7 at a much faster rate than the agitator 3.

It is also contemplated that the spreader could take the form of a cylindrical barrel mounted to the frame 20. Longitudinal bars could be mounted to the barrel. The spreader need simply be adapted to impart tangential velocity to the granulated material that comes into contact with it.

A baffle 10 is mounted adjacent to the spreader 30. Preferably, the baffle 10 is a shaped obstruction that is attached to the frame 20 by way of fasteners. The shaped obstruction can be in the form of a curved or angled sheet that can be metal or other durable product. The baffle 10 is adapted to deflect any granulated material coming into contact with it towards the surface over which the device 40 is travelling.

Dropping from hopper 1 through delivery slot 2, the granular material hits the working face 49 of rotating radial vanes 30. If the granular material is moist, the granular material may come out of the delivery slot 2 in small clumps. When the working faces 49 of rotating vanes 30 strike the falling granular material, the force of the contact causes the granular material to break down into granular sizes. The rotating radial vanes 30 propel the granular material against the baffle 10, with the impact resulting in the further breakdown of any clumps of granular material as it is deflected towards the ground by the baffle 10. The cumulative effect of the agitator, spreader and baffle is a consistent, thin, wide layer of granular material being deposited on the ground.

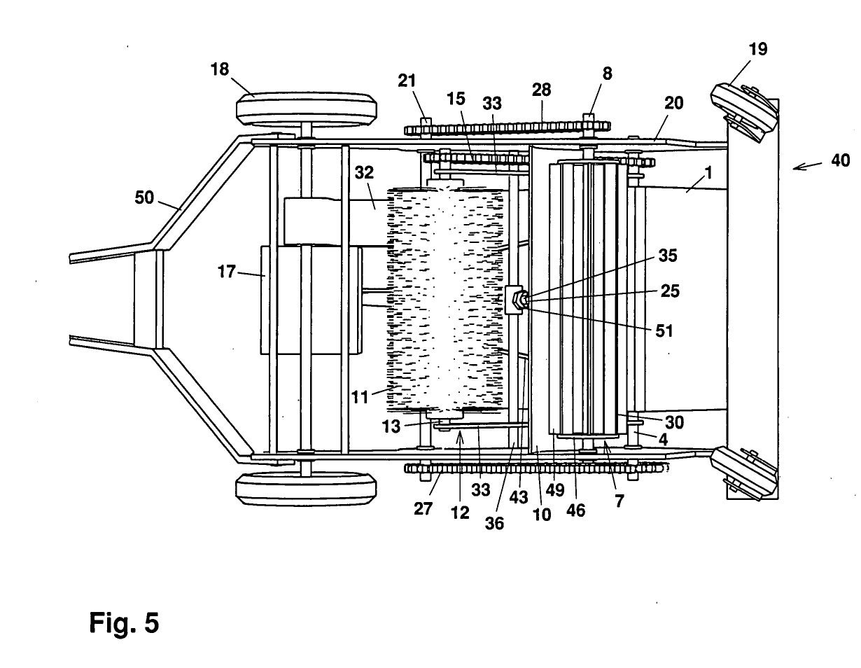

A sweeper 11 is mounted to frame 20 as illustrated best in FIGS. 5, 6, and 7. Preferably, the sweeper 11 is a rotary sweeping brush mounted on a sweeper drive shaft 13 that is in the lower end of a swing arm assembly 12 having an upper end which pivots freely around agitator drive shaft 4. The swing arm assembly 12 is comprised of two sweeper side bars 33 and a swing arm stiffening bar 34. A sprocket 14 is connected to the drive shaft 4 and a further sweeper sprocket 16 is connected to sweeper drive shaft 13. A sweeper drive chain 15 connected to both drive sprocket 14 and sweeper sprocket 16 transfers power from drive shaft 4 to sweeper shaft 13 thereby effecting rotation of the sweeper 11. The direction of rotation of the sweeper 11, when actuated, is indicated by arrow 39. Even pressure of the sweeping contact is maintained by the use of a biasing force, for example a simple sweeper stabilizer spring 25 which is around a telescoping pivotal shaft 35 that is attached to the swing arm stiffening bar 34 and a cross brace 36 connected to frame 20. A nut 51 is fitted over a threaded section at the upper end of the telescoping pivotal shaft 35. Adjusting the position of nut 51 on telescoping pivotal shaft 35 threaded section can slightly raise or lower the sweeper and, thus, change the contact with the surface in order to compensate for sweeper wear. Because the swing arm assembly 12 is able to pivot about drive shaft 4, the powered sweeper 11 can respond to the contours of the ground over which it travels, rising and falling as necessary.

Other methods of stabilizing the pressure of the sweeper to the surface can be accomplished with the use of hydraulics, such as a shock absorber, electronic sensing, or by having a manual adjustment of the swing arm assembly to either raise or lower the height of the sweeper to the surface.

Preferably a clutching belt provides primary drive and gear reduction so that all systems may be de-clutched by a single operator control.

Operation of the device with granular material will now be discussed. Granular material is placed in the hopper 1 for disbursement by the device 40. After assessing the surface upon which granular material is to be placed, the operator sets the metering slide adjustor to suit the granular material requirements. Positioning of the sweeper may also be adjusted as necessary by way of nut 51. After the engine 17 is started, the operator engages the clutch so as to apply power to the various component elements of the device 40. When it is activated, the agitator 3 is rotated by the drive shaft 4 such that the agitator tines 26 are driven through the granulated material in the hopper 1 thereby acting to break down clumps of granulated material. The rotating motion of the agitator 3 is also such that the protruding agitator tines 26 act to force granular material towards the delivery slot 2. Granular material driven through the delivery slot 2 falls on the spreader 7.

Power being applied to the spreader 7 causes it to spin rapidly. The working faces 49 of the radial vanes 30 of the rapidly spinning spreader 7 catch the falling granular material and impart tangential velocity to the granular material, flinging it against the baffle 10. Impact of the granular material against the baffle 10 granulates any remaining clumps, the baffle 10 deflecting a consistent swathe of separated granular material grains upon the grass surface. Following immediately behind the baffle 10, the rotating sweeper 11 sweeps the granular material forward and down between the grass blades to the substrate.

The operator directs the device 40 by way of the handle 50 connected to the frame 20. The handle 50 is fitted with the operator controls and acts to provide leverage for steering. The operator squeezes and holds the clutch control lever (not shown) against the handle grip thereby causing power to be transferred from the engine 17 to all systems. The engine governor system maintains the RPMs as set by the throttle control (not shown). The throttle lever may be fine-tuned for operator preferences, if required. When the chosen point on the lawn is reached, the squeezing and holding of another lever (not shown) pulls cable 31 thereby moving the metering slide 6 to its preset position and commencing granular material dispensing. By releasing the drive clutch lever forward propulsion and granular material delivery will be stopped. Similarly, the operator need simply release the granular material control lever to cut off granular material delivery while still delivering propulsion.

It will be appreciated by those skilled in the art that the preferred and alternative embodiments have been described in some detail but that certain modifications may be practiced without departing from the principles of the invention.

1. A device for depositing granulated material on a surface comprising:
a wheeled frame;
a container for holding the granulated material, said container being mounted to said frame and having a first opening through which the granulated material is added and a second opening through which the granulated material is dispensed;
an agitator mounted in the container, said agitator being adapted to overcome clumping of the granulated material when activated;
a spreader mounted to said frame below said second opening of said container, said spreader being adapted to impart tangential velocity to granulated material that comes into contact with it during operation;
a baffle mounted to said frame, said baffle positioned adjacent to said spreader such that granulated material propelled by said spreader is deflected by said baffle;
a sweeper which acts to sweep the granulated material on the ground surface; and
a power source providing power to said device.

2. The device of claim 1 wherein the size of said second opening is adjustable.

3. The device of claim 2 wherein adjustment of the size of said second opening is accomplished by way of a metering slide slidably connected to said container.

4. The device of claim 3 further comprising a cable connected to said metering slide and a metering slide adjustor adapted to limit the movement of said metering slide.

5. The device of claim 1 wherein said agitator comprises a tube portion having a plurality of protruding tines.

6. The device of claim 5 wherein said tube portion is mounted on a shaft, said shaft being mounted to said container and drivable by said power source.

7. The device of claim 1 wherein said spreader is rotatable about a drive shaft.

8. The device of claim 7 wherein said spreader comprises a pair of opposed circular end plates mounted to said drive shaft and having a plurality of radial vanes mounted therebetween.

9. The device of claim 8 wherein said radial vanes being perpendicular to said circular end plates and parallel to said drive shaft, each of said radial vanes having a working face lying in a radial plane.

10. The device of claim 7 wherein said spreader comprises a cylindrical member mounted horizontally.

11. The device of claim 10 wherein said cylindrical member has a plurality of parallel, elongated bars.

12. The device of claim 1 wherein said baffle comprises a metal sheet attached to said frame.

13. The device of claim 1 wherein said sweeper comprises a rotary sweeping brush.

14. The device of claim 13 wherein said rotary sweeping brush being mounted to a swing arm assembly, said swing arm assembly being pivotable and biased so as to hold said rotary sweeping brush in contact with said surface.

15. The device of claim 14 wherein said swing arm assembly is pivotable about a drive shaft passing through said container.

16. The device of claim 14 wherein said swing arm is biased by a spring.

17. The device of claim 16 wherein said spring is positioned on a telescoping pivotal shaft attached to a cross brace mounted on said frame.

18. A device for depositing granulated material on a surface comprising:
a wheeled frame;
a container for holding the granulated material, said container being mounted to said frame and having a first opening through which the granulated material is added and a second opening through which the granulated material is dispensed;
an agitator mounted in the container, said agitator being adapted to overcome clumping of the granulated material when activated;
a baffle mounted to said frame for deflecting said granulated material towards said surface; and
a power source providing power to said device.

19. The device of claim 18 further comprising a sweeper which acts to sweep the granulated material on the ground surface.

20. A device for depositing granulated material on a surface comprising:
a wheeled frame;
a container for holding the granulated material, said container being mounted to said frame and having a first opening through which the granulated material is added and a second opening through which the granulated material is dispensed;
a spreader mounted to said frame below said second opening of said container, said spreader being adapted to impart tangential velocity to granulated material that comes into contact with it during operation;
a baffle mounted to said frame, said baffle positioned adjacent to said spreader such that granulated material propelled by said spreader is deflected by said baffle;
a sweeper which acts to sweep the granulated material on the ground surface; and
a power source providing power to said device.
